(19) United States
(12) Patent Application Publication
(10) Pub. No.: US 2025/0389913 A1
(43) Pub. Date: Dec. 25, 2025

(54) High-Speed Optical Transceiver

(71) Applicant: Nippon Telegraph and Telephone Corporation, Tokyo (JP)

(72) Inventors: Josuke Ozaki, Musashino-shi, Tokyo (JP); Yoshihiro Ogiso, Musashino-shi, Tokyo (JP); Takashi Yamada, Musashino-shi, Tokyo (JP)

(21) Appl. No.: 18/879,532

(22) PCT Filed: Jul. 11, 2022
(86) PCT No.: PCT/JP2022/027321

§ 371 Date: Dec. 27, 2024

(51) Int. Cl. G02B 6/42

(52) U.S. Cl. CPC G02B 6/4274; G02B 6/4246

(57) ABSTRACT

An optical transceiver includes a pad formed on the surface of a DSP package substrate. an optical modulation module, a package that accommodates the optical modulation module, and a pad formed on the surface of the package, and the DSP package substrate and the package are directly connected to each other by the pad and the pad.

### TECHNICAL FIELD

The present disclosure relates to a high-speed optical transceiver.

### BACKGROUND ART

Digital signal processing technologies, including digital coherent, have been introduced into optical fiber communication systems, backbone network transmission technology with a transmission rate of 100 Gbps per wavelength has been established, and currently, the speed has reached a practical level of 400 to 600 Gbps per wavelength.

FIG. 1(a) is a top view showing a known 100 G digital coherent system, and FIG. 1(b) is a cross-sectional view along arrow lines Ib and Ib in FIG. 1(a). Since the cross-sectional views in FIGS. 1(b), 2(b), 3(b), 4, and 5 are intended to describe the arrangement of components, illustration of the internal configurations of the components is omitted. Each component (integrated circuit (IC), photo integrated circuit (photo IC)) shown in FIGS. 1(a) and 1(b) is individually packaged, and each component is mounted on a printed circuit board (PCB) 100, for example. FIGS. 1(a) and 1(b) show an example of a known 100 G digital coherent system. In the known 100 G digital coherent system, a digital signal processing (DSP) package substrate 110 is mounted on the PCB 100, and in the known 100 G digital coherent system, the DSP package substrate 110 is electrically connected to the PCB 100 by a ball grid array (BGA) 101 on the PCB 100. A DSP application specific integrated circuit (ASIC) 111 chip is mounted on the DSP package substrate 110.

The electrical input/output of the DSP package substrate 110 is connected to a driver/TIA 130 via surface mount lead pins 102 by printed wiring on the PCB 100, and is connected to an optical modulation module/light receiving module (hereinafter also referred to as an optical modulation (light receiving) module) 120 via the driver/TIA 130. Note that when reference numeral 120 denotes an optical modulation module, reference numeral 130 corresponds to a driver, and when reference numeral 120 denotes a light receiving module, 130 corresponds to a TIA. The optical modulation (light receiving) module 120 receives a modulated electrical signal, performs optical modulation, outputs the modulated light to an optical fiber 140, converts the signal light received from the optical fiber 140 into an electrical signal, and sends the electrical signal to the DSP package substrate 110, and the DSP-ASIC 111 processes the received signal.

In a system exceeding 400 G, analog components are required to have a wide band (for example, a modulation band of 40 GHz or more), and therefore, further reduction in high frequency loss and miniaturization are required. FIGS. 2(a) and 2(b) are views showing a known 400 G digital coherent system configured to meet such requirements, where FIG. 2(a) is a top view and FIG. 2(b) is a cross-sectional view along arrow lines IIb and IIb in FIG. 2(a). The 400 G digital coherent system shown in FIGS. 2(a) and 2(b) is configured by mounting, on a PCB 200, a DSP package substrate 210 on which a DSP-ASIC 211 is mounted and an integrally mounted optical modulation (light receiving) module 225 in which the driver/TIA 130 and the optical modulation (light receiving) module 120 are integrally mounted. Reference numeral 240 indicates an optical fiber, through which light is transmitted and received. In this way, a form in which an RF driver and an optical modulator are mounted in an integrated package on the transmitting side (coherent driver modulator: CDM) and a form in which a transimpedance amplifier TIA and an optical receiver PD are mounted in an integrated package on the receiving side (integrated coherent receiver: ICR) are hereinafter collectively referred to as a CDM form.

FIGS. 3(a) and 3(b) are views showing a known 400 G digital coherent system for suppressing high frequency characteristic deterioration due to package mounting, where FIG. 3(a) is a top view and FIG. 3(b) is a cross-sectional view along arrow lines IIIb and IIIb in FIG. 3(a). The 400 G digital coherent system shown in FIGS. 3(a) and 3(b) includes a DSP package substrate 310 on a PCB 300, and all high frequency analog ICs (a DSP-ASIC 311, a driver/TIA 330, an integrally mounted optical modulation (light receiving) module 325) are mounted on the DSP package substrate 310 (DSP co-package mounting). An optical fiber 340 is connected to the integrally mounted optical modulation (light receiving) module 325. Note that in such a configuration, since the DSP-ASIC 311, which generates a watt-class amount of heat, and an optical transceiver are placed close to each other on the same DSP package substrate 310, it is preferable to select an optical transceiver that exhibits small characteristic fluctuations (small temperature dependence) with respect to changes and increases in temperature.

FIG. 4 is a longitudinal cross-sectional view showing a digital coherent system using low-loss flexible printed circuits (FPCs) as a high frequency interface of an optical module in a known CDM-mounted system. In the digital coherent system shown in FIG. 4, a DSP package substrate 410 is connected to a PCB 400 via a BGA 401, and a DSP-ASIC 411 is mounted on the DSP package substrate 410. The DSP package substrate 410 is connected to an integrally mounted optical modulation (light receiving) module 425 via an FPC 450. Input light and output light of the integrally mounted optical modulation (light receiving) module are conducted through an optical fiber 440.

Furthermore, as an optical transceiver material, in place of the conventional lithium niobate (LN) optical modulator, semiconductor-based optical modulators are attracting attention from the viewpoint of miniaturization and cost reduction. In particular, compound semiconductors typified by InP are mainly used for faster modulation operations. In systems where miniaturization and cost reduction are important, research and development of Si-based optical devices is being conducted. Semiconductor optical modulators also have advantages and disadvantages specific to their materials; for example, in InP optical modulators, temperature controller control is considered essential during modulation operation in order to control band edge absorption effects. On the other hand, although Si modulators have the advantage of not requiring temperature control, since the electro-optic effect is smaller than that of other material systems, it is necessary to lengthen the electric-optical interaction length, which may result in increased high frequency loss, and there are many problems to be solved in further increasing the speed (wideband).

In order to further speed up the known digital coherent systems shown in FIGS. 1(a) to 3(b), it is important not only to increase the speed of ICs (for example, Si-CMOS, etc.) and PICs (for example, circuits including optical modulating elements, light receiving elements, etc.), but also to increase the speed of packages and high frequency wiring (lower RF loss), and to reduce the loss (lower reflection) of electrical connections between components. From this point of view, the multi-chip co-package form shown in FIGS. 2(a) to 3(b) is more advantageous in speeding up the mounting than the configurations shown in FIGS. 1(a) and 1(b). Against this background, a more highly integrated DSP co-package form is being considered for Si-based optical modulators with low temperature dependence, while for InP-based optical modulators with large temperature dependence, a form (for example, CDM) in which only a high frequency amplification element (driver IC) is mounted in the same package as a separate package from a DSP that generates a large amount of heat is often employed. Note that the optical modulating element here is generally mounted on a thermoelectric cooler (TEC), and is controlled so that the temperature is constant. A technology for suppressing deterioration of transfer characteristics due to high frequency loss in an internal high frequency line of a digital coherent optical receiving device is described in, for example, PTL 1. PTL 2 describes a high-speed optical transceiver that connects a package substrate and an optical module through a flexible substrate and transmits and receives light at a high speed. NPL 1 discloses a wideband CDM that operates at rates of 64 GBd, 96 GBd, 128 GBd or higher.

### CITATION LIST

### Patent Literature

[PTL 1] Japanese Patent Application Publication No. 2015-146515

[PTL 2] WO 2021/171599 A1

### Non Patent Literature

[NPL 1] Richard J. R. B. Ward, and two others, “Implementation Agreement for High Bandwidth Coherent Driver Modulator (HB-CDM)” [online], Jul. 15, 2021. [retrieved on June 24, 2022], Internet https://www.oiforum.com/wp-content/uploads/OIF-HB-CDM-02.0.pdf

### SUMMARY OF INVENTION

The mounting forms of known semiconductor optical modulators are mainly classified into a CDM form as shown in FIG. 2 (also called ICR on the receiver side, and IC-TROSA: integrated coherent transmitter and receiver optical sub-assembly in the case of a transmitter/receiver integrated package) and a DSP co-package form as shown in FIG. 3. Here, in order to further increase the speed of the entire optical transmitter (receiver), it is necessary to increase the speed of each IC and PIC, as well as the wiring that connects them and the package mounting (wideband). However, the two known mounting forms mentioned above each had the following problems that hindered widebanding.

### Problem in CDM Form

For example, a high-speed analog electrical signal output from a digital/analog conversion circuit (DAC) provided in a DSP-ASIC is propagated from the ASIC to the DSP package substrate to the PCB to the optical modulation module and is converted into an optical signal. For example, surface mount technology (SMT), flexible printed circuits (FPCs), or flexible printed wiring boards are used as the electrical interface. In this case, it is necessary to propagate electrical signals across a plurality of different types of high frequency circuit boards, and as the length of the electrical wiring becomes longer, electrical loss increases.

Furthermore, in connections between substrates, particularly in ball grid array (BGA) connection portions between a DSP package substrate and a PCB, solder balls with a diameter of 100 to several hundred μm are used for connection. When the propagating electrical signal becomes a high frequency signal of 50 GHz or more, electrical reflection caused by impedance mismatch at the solder ball connection location becomes a factor that greatly deteriorates the high frequency characteristics. Although this deterioration of high frequency characteristics was not raised as a major problem in the known 400 G system (modulation drive baud rate of 64 GBaud rate, required band of approximately 40 GHZ), this will be a major barrier to the realization of next generation 800 G and IT systems (required band>50 GHZ). Therefore, even if an optical modulation module equipped with an InP modulating element having a modulation band of 50 GHz or more is used, it is difficult to ensure the band characteristics of the entire optical transmitter (receiver).

Furthermore, as shown in FIG. 4, in a known CDM mounting system, in an example in which a low-loss FPC 450 is used as a high frequency interface of an optical module, the FPC is connected to the PCB 400 from the optical module terrace portions having different heights. According to such a configuration, it is necessary to strongly bend the low-loss FPC 450 for mounting, and there are concerns about fluctuations in high frequency characteristics (changes in characteristic impedance) due to bending and increased electrical loss due to longer wiring.

FIG. 5 is a longitudinal cross-sectional view of a digital coherent system in which the DSP package substrate 410 and an integrally mounted optical modulation module 425 are directly connected in a flat manner using an FPC 550 in order to solve the above problem.

### Problem in DSP Co-Package Form

A widely known method for solving the above problem is the mounting form of the DSP co-package shown in FIG. 3. As shown in FIG. 3, in this mounting form, not only the DSP-ASIC 311 but also the driver (TIA) 330 and the optical modulator (optical receiver) PIC 325 are mounted on the DSP package substrate 310, and high frequency electrical signals are fed to the optical modulator through the shortest wiring without going through solder balls or the like. However, as current optical modulators, Si-based modulators with small temperature dependence are mainly used, and as mentioned above, in order to further increase the speed (wideband), a major problem is improving the characteristics of the optical modulating element itself.

Generally, there is a trade-off relationship between the band of an optical modulator and modulation efficiency (corresponding to drive voltage Vx, modulated output light intensity, etc.). For this reason, simply designing with priority given to band expansion will actually lead to deterioration of a signal-to-noise ratio (SNR) of modulated light, resulting in deterioration of signal quality. Furthermore, in order to compensate for the deterioration of the SNR, when a compound semiconductor optical amplification element such as SOA is mounted separately from the Si modulating element, problems include temperature control of the amplification element itself, increased costs and increased power consumption due to an increase in the number of mounted components. Furthermore, when using an InP modulator instead of a Si modulator for DSP co-packaging, it is necessary to change the composition of the InP modulator core (to reduce the band edge absorption of the material), but in this case, the modulation efficiency of the InP modulator itself decreases (quantum confined Stark effect: QCSE decreases), resulting in a problem of deterioration of an SNR.

The present disclosure has been made in view of the above points, and relates to a high-speed optical transceiver that shortens the length of wiring connecting a digital signal processing circuit and a module including an optical element, and provides high speed and low signal loss.

To achieve the above object, according to one aspect of the present disclosure, there is provided a high-speed optical transceiver including: a digital signal processing circuit; a first electrode formed on a first package substrate of the digital signal processing circuit; an optical element; a second package that accommodates the optical element; and a second electrode formed on a surface of the second package, in which the first package substrate and the second package are directly connected to each other by the first electrode and the second electrode.

According to the above-described aspect, by forming electrodes directly on the package of the digital signal processing circuit and the package of the module including the optical element, and connecting them directly, the length of the signal wiring connecting the two can be shortened to the minimum, thereby increasing signal speed and reducing loss.

### BRIEF DESCRIPTION OF DRAWINGS

FIG. 1(a) is a top view showing a known 100 G digital coherent system, and FIG. 1(b) is a cross-sectional view along arrow lines Ib and Ib in FIG. 1(a).

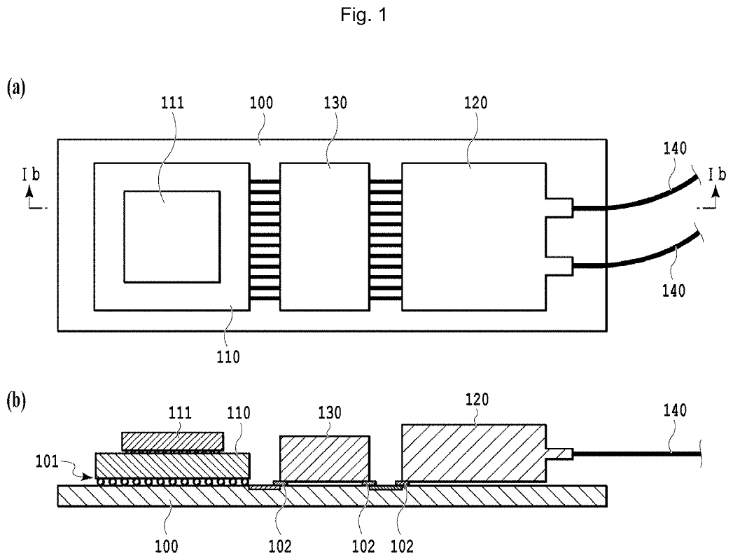

FIG. 2(a) is a top view showing a known 400 G digital coherent system, and FIG. 2(b) is a cross-sectional view along arrow lines IIb and IIb in FIG. 2(a).

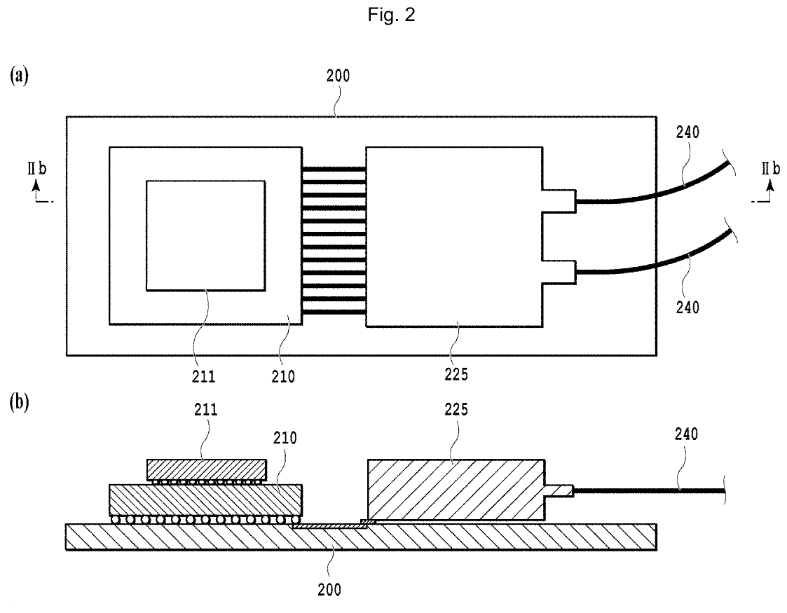

FIG. 3(a) is a top view showing another known 400 G digital coherent system, and FIG. 3(b) is a cross-sectional view along arrow lines IIIb and IIIb in FIG. 3(a).

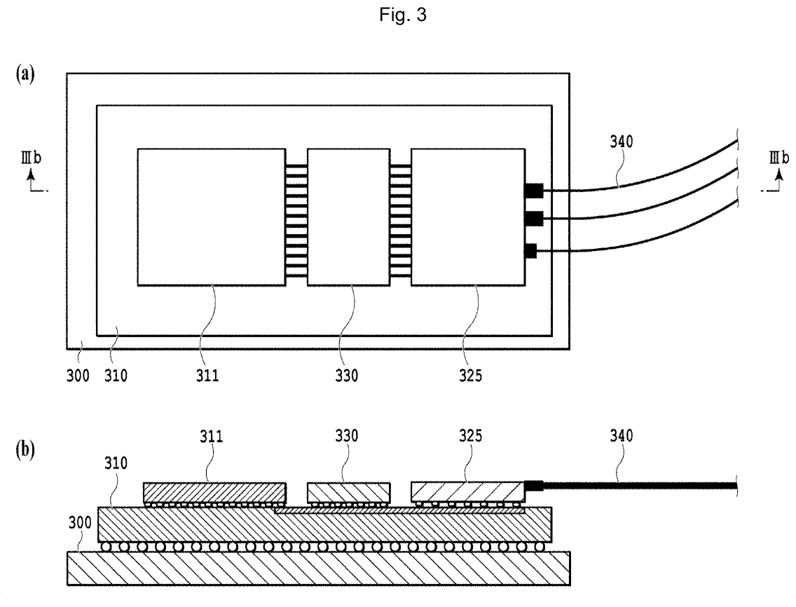

FIG. 4 is a longitudinal cross-sectional view showing a digital coherent system using a low-loss FPC as a high frequency interface of an optical module.

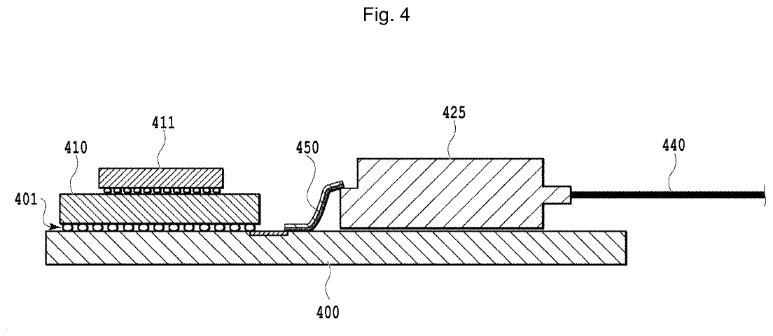

FIG. 5 is a longitudinal cross-sectional view showing a digital coherent system in which a DSP package substrate and an integrally mounted optical modulation module are directly connected in a flat manner using an FPC.

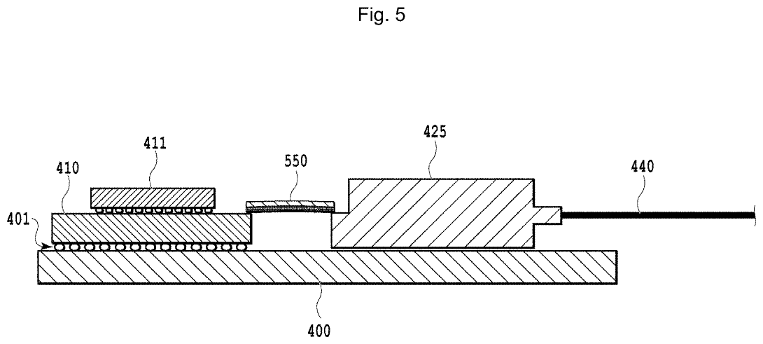

FIG. 6 is a longitudinal cross-sectional view for describing an optical transceiver according to an embodiment of the present disclosure.

FIG. 7 is a view for describing a height or thickness of each portion of the configuration shown in FIG. 6.

FIG. 8(a) is a plan view for describing pads formed on the DSP package substrate, FIG. 8(b) is a plan view for describing pads formed on the optical modulation module, FIG. 8(c) is an enlarged view of the pads shown in FIGS. 8(a) and 8(b), and FIG. 8(d) is a view for describing a heating pad formed on the back surface of the surface shown in FIG. 8(b).

FIG. 9 is a longitudinal cross-sectional view of the optical modulation module shown in FIGS. 6 and 7.

FIG. 10 is a view showing a state in which the optical modulation module shown in FIG. 9 is mounted on the DSP package substrate.

### DESCRIPTION OF EMBODIMENTS

An embodiment of the present disclosure will be described below with reference to the drawings. The drawings used in the present embodiment are intended to describe the configuration of the present disclosure, each member included in the configuration, the positional relationship between the members, functions, effects, and technical ideas. Therefore, the drawings do not limit the specific shape of the present disclosure, and the drawings do not necessarily accurately depict the aspect ratio or thickness of the configuration of the present disclosure. In particular, the cross-sectional views omit illustration of the internal structure, except for some parts.

### Connection Between Digital Signal Processing Circuit and Module Including Optical Element

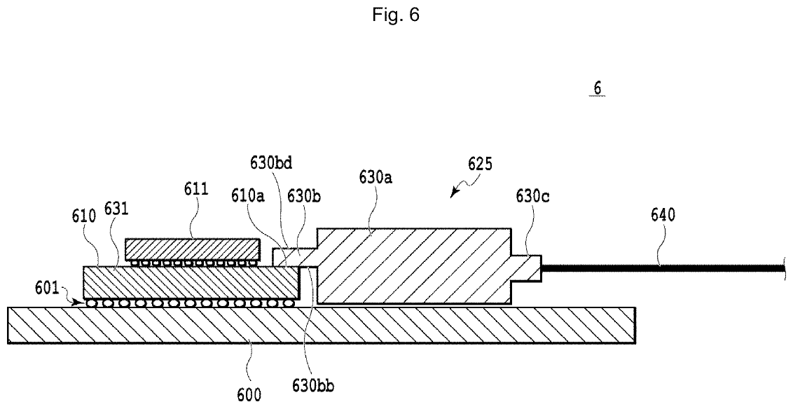

FIG. 6 shows a state in which a DSP package substrate 610 and an optical modulation module 625 are connected to form an optical transceiver 6. The optical transceiver 6 is a high-speed optical transceiver according to the present embodiment. FIG. 6 is a longitudinal cross-sectional view for describing the optical transceiver 6 according to the present embodiment. The optical transceiver 6 includes a PCB 600, a DSP package substrate 610, a DSP-ASIC 611, and an integrally mounted optical modulation module 625 (hereinafter simply referred to as an “optical modulation module”). The DSP package substrate 610 is mounted on the PCB 600, and the DSP-ASIC 611 is mounted on the DSP package substrate 610. The length in a stacking direction from the upper surface of the PCB 600 to each portion of the optical transceiver 6 is referred to as a “height”. Here, the stacking direction refers to the direction in which the DSP package substrate 610 is mounted (stacked) on the PCB 600. Further, the length of each portion of the optical transceiver 6 in the stacking direction is referred to as a “thickness”.

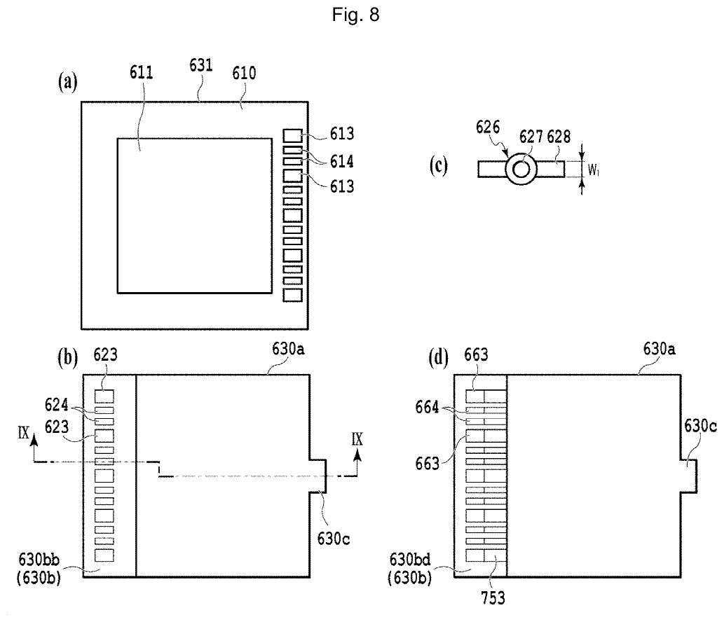

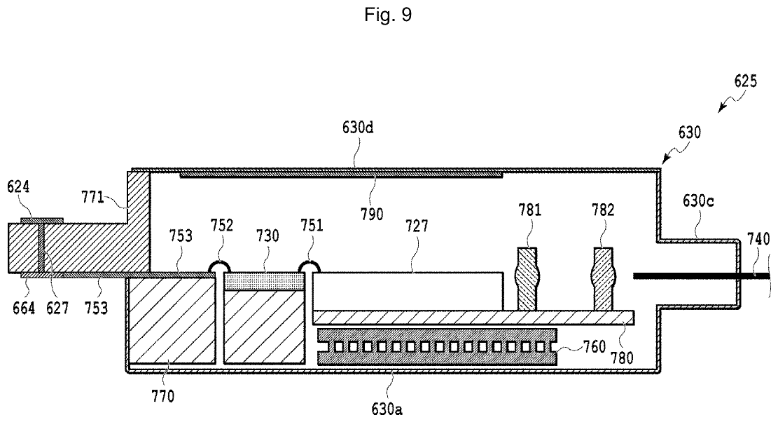

The optical transceiver 6 includes a DSP package substrate 610 including a digital signal processing circuit. Pads 613 and 614 (FIG. 8(a)), which are first electrodes, are formed on the DSP package substrate 610. Further, the optical modulation module 625 includes an optical element and a package 630 (second package) that accommodates the optical element. As will be described later, the present embodiment uses an example in which an optical modulation module 625 including an optical modulator PIC (FIG. 9), which is an optical modulating element, is used. However, the present embodiment is not limited to such an example, and the module may be an optical receiving module including a light receiving element, or may be an optical transmitting/receiving module including both an optical modulating element and a light receiving element.

In the present specification, a “module” refers to a set of a plurality of elements aggregated to perform a predetermined function, and includes both the elements constituting the set and the elements accommodated in a package. The module may include other elements in addition to the optical element. As will be described later, the optical modulation module 625 accommodates, together with an optical modulator PIC 727, a gold wire wiring 751, a high frequency wiring 753, a TEC 760, a module wiring board base 770, an optical element base 780, a chip condenser lens 781, a fiber condenser lens 782, and a high frequency amplification IC (driver IC) 730 in the package 630 (FIG. 9).

The package 630 shows a high frequency ceramic package used in a general optical module. The package 630 includes an RF terrace portion 630b, a fiber pipe portion 630c, and a package body 630a as main portions. The package body 630a is a portion for accommodating the above-mentioned components as a unit. The RF terrace portion 630b is a portion extending toward the DSP package substrate 610, and the RF terrace 630b is made of ceramic, and includes pads 623 and 624 (FIG. 8(b)), which are second electrodes, on a lower surface 630bb. The DSP package substrate 610 and the package 630 of the optical modulation module 625 are connected by directly connecting the pads 613 and 614 and the pads 623 and 624.

A package includes a case portion that seals and protects electronic circuits and elements, and terminals and pads for electrically connecting the sealed circuits and elements to the outside. However, the term “package” in the present specification mainly refers to the case portion.

The integrally mounted optical modulation module 625 is an optical modulation module in which a driver IC 730 (FIG. 9), which will be described later, and an optical modulation module are integrally mounted. The fiber pipe portion 630c indicates a pipe portion of the package 630 from which a fiber 640 extends. Connection pads are formed on the ceramic RF terrace portion 630b and are used for RF connection with the DSP package substrate 610.

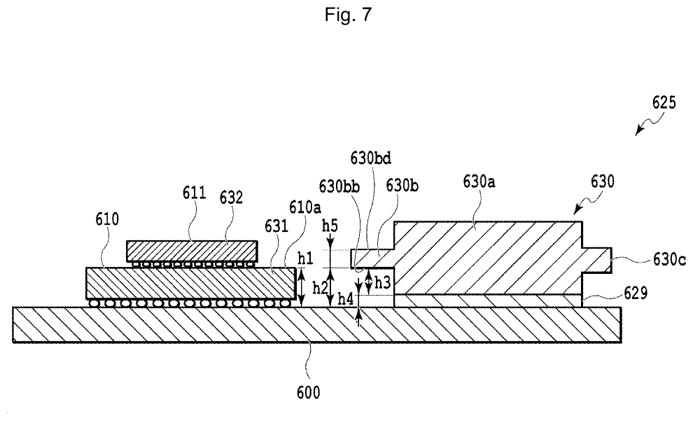

FIG. 7 is a view for describing the height or thickness of each portion of the configuration shown in FIG. 6, and shows a state in which the DSP package substrate 610 and the optical modulation module 625 are not yet connected. In FIG. 7, the height of an upper surface 610a of the DSP package substrate 610 is denoted by h1, the height of the lower surface 630bb of the RF terrace portion 630b is denoted by h2, the height to the bottom surface of the package 630 is denoted by h4, the thickness of an underfill agent 629 filling the gap between the package bottom surface and the lower surface 630bb is denoted by h3, and the thickness of the RF terrace portion 630b is denoted by h5. The optical transceiver 6 has pads on both the DSP package substrate 610 and the optical modulation module 625, and by directly connecting the pads, the wiring is made as short as possible, and the operation speed is increased. Because of this configuration, in the present embodiment, it is preferable that a difference in height between the height h2 of the lower surface 630bb of the RF terrace portion and the height h1 of the upper surface 610a of the DSP package substrate 610 be zero or as small as possible.

FIG. 6 shows a state in which the height of the lower surface 630bb of the RF terrace portion is equal to the height of the upper surface 610a of the DSP package substrate 610. However, it is known that there may be a difference between the height h1 and the height h2 when manufacturing tolerances and the like in manufacturing the optical transceiver 6 are considered. As shown in FIG. 7, when the thickness of a main body 625a is lower than the height h1 of the DSP package substrate 610, the allowable difference in height between the thickness of the main body 625a and the height h1 during mounting is 500 μm or less. This difference in height is a value that takes into consideration the stability of connection with the optical modulation module 625 and actual variations.

When the difference in height is 500 μm or less, by filling a space between the bottom surface of the package 630 and the PCB 600 with the underfill agent (conductive adhesive) 629, and filling the gap between the optical modulation module 625 and the PCB 600 and fixing the optical modulation module 625, it is possible to prevent the optical modulation module 625 from floating and ensure long-term reliability of the connection portion.

Furthermore, considering the mounting process, the DSP package substrate 610 is mounted on the PCB 600 before the optical modulation module 625 is mounted. Therefore, when the height of 625bb becomes higher than the upper surface 610a of the DSP package substrate 610 during mounting, a difference in height occurs between the DSP package substrate 610 and the optical modulation module 625 at that point of time. At this time, when 625bb becomes higher than the upper surface 610a of the DSP package substrate 610, it becomes impossible to connect the DSP package substrate 610 and the optical modulation module 625. Therefore, the height h3 of the lower surface 625bb needs to be equal to or less than the height h1 of the upper surface 610a of the DSP package substrate 610.

Note that in the present embodiment, the DSP-ASIC 611 and the optical modulation module 625 have a heat dissipation surface, and both have the heat dissipation surface as the upper surface. The “heat dissipation surface” or “side that dissipates heat” in the present embodiment does not refer to all the surfaces or sides where heat dissipation occurs, but refers to the surface or side where the main heat dissipation occurs among the surfaces or sides where heat dissipation occurs. The surface or side where the main heat dissipation occurs may be, for example, the surface or side from which heat is radiated by a heat dissipation mechanism. As the heat dissipation mechanism, for example, a Peltier element or a heat sink can be considered. In the present embodiment, the heat dissipation surface can be placed on the lower side, but in such a case, it is necessary to provide a mechanism for heat dissipation on the PCB 600 side. This is undesirable because it increases the number of parts or steps for the optical transceiver. Furthermore, since the heat dissipation surface of the DSP package substrate 610 is formed on the upper side, when the heat dissipation surface of the optical modulation module 625 is placed on the lower side, heat dissipation surfaces are formed on both the upper and lower sides of the optical transceiver 6. In the present embodiment, it is desirable that the heat dissipation surfaces of the entire optical transceiver 6 be aligned to be formed on the upper side by forming the heat dissipation surface of the optical modulation module 625 on the upper side.

### Connection of Electrodes

Next, electrodes formed on the upper surface 610a of the DSP package substrate 610 and the lower surface 630bb of the package 630 will be described. FIGS. 8(a), 8(b), and 8(c) are views for describing such electrodes, where FIG. 8(a) shows the upper surface 610a and FIG. 8(b) shows the lower surface 630bb. That is, FIG. 8(a) is a plan view of the DSP package substrate 610 viewed from above, and FIG. 8(b) is a plan view of the package 630 of the optical modulation module 625 viewed from the lower surface 630bb side (from below). FIG. 8(c) is an enlarged view of the upper surface of a signal pad shown in FIG. 8(b). FIG. 8(d) is a view showing an upper surface 630bd that is the back surface with respect to the lower surface 630bb shown in FIG. 8(b).

As shown in FIGS. 8(a) and 8(b), the upper surface 610a and the lower surface 625bb facing the upper surface 610a of the DSP package substrate 610 are both provided with two types of electrodes (pads) having different sizes. Among the pads formed on the upper surface 610a, the larger pad 613 functions as a GND PAD, and the smaller pad 614 functions as a Signal PAD. Similarly, among the pads formed on the lower surface 625bb, the larger pad 623 functions as a GND PAD, and the smaller pad 624 functions as a Signal PAD.

The pads 613 and 623 and the pads 614 and 624 are arranged to overlap each other when the upper surface 610a and the lower surface 630bb are overlapped. In the present embodiment, the upper surface 610a corresponds to the surface on which the pads 613 and 614 are formed, and the lower surface 630bb corresponds to the surface on which the pads 623 and 624 are formed. The formation surface is the surface of the package 630.

The examples shown in FIGS. 8(a) and 8(b) show a GSSG configuration with a differential line configuration. However, the present embodiment is not limited to such a configuration, and may be a GSGSG configuration. Further, the number of pads shown in FIGS. 8(a) and 8(b) is an example, and the number of pads is arbitrary depending on the required number of channels.

FIG. 8(c) is an example of a detailed drawing of the pad 624. The pad 624 includes a signal pad 628 shown as a rectangle, a land 626 formed on the signal pad 628, and a through hole 627 formed in the land 626. Note that although FIG. 8(c) only shows the pad 624 serving as a Signal PAD, the pad 623 serving as a GND PAD is also configured in the same manner as the pad 624. Therefore, in the present embodiment, illustrations and descriptions of the configuration related to the through holes of the pads 623 and the like are omitted.

By forming the through hole 627, it is possible to apply heat to melt the solder when connecting to the DSP package substrate 610. Here, the through hole 627 is expressed as an example, but from the viewpoint of heat conduction, it does not necessarily have to be a cavity, and may be an embedded VIA. However, when an embedded VIA is used, it cannot have the role of flowing solder, which will be described later. As an example, only one through hole 627 is shown, but it is also possible to include a plurality of through holes or to use a half through hole. Similarly, it is essential that at least one through hole 627 be formed on the side of the pad 623 (GND PAD) in order to apply heat. In this way, the pads 623 and 624 are configured so that they can be heated via the through hole 627, but in order to make heating easier, in addition to increasing the number of through holes 627, it is also effective to provide a heating pad with a size equal to or smaller than the width of the signal pad 628 on the upper surface 630bd of the RF terrace portion 630b on the opposite side from the lower surface 630bb, for example. However, since the capacitance increases, it is desirable that the size of the heating pad (mainly in the width direction) be smaller than the size of the connection pad.

A specific example of heating pads 663 and 664 is shown in FIG. 8(d). The heating pads 663 and 664 are formed on the upper surface 630bd. The pad (Signal PAD) 624 formed on the lower surface 630bb is connected to the heating pad 664 on the upper surface 630bd through the above-mentioned through hole 627. Further, the width (w1) of the heating pad 664 is narrower than that of the pad 624 on the lower surface 630bb. Similarly, the pad (GND PAD) 623 formed on the lower surface 630bb is connected to the heating pad 663 formed on the upper surface 630bd through the through hole 627. In FIGS. 8(b) and 8(d), regarding the GND PAD, the widths of the pad 623 (GND PAD) and the heating pad 663 are the same, but this is not necessarily the case. Further, the heating pads 663 and 664 on the upper surface 630bd are connected to the high frequency wiring 753 and transmit high frequency signals into the inside of the package 630. A cross-sectional image along arrow lines IX and IX in FIG. 8(b) is shown in FIG. 9.

FIG. 9 is a longitudinal cross-sectional view of the optical modulation module 625 of the present embodiment along arrow lines IX and IX in FIG. 8(b). The longitudinal cross-sectional view shown in FIG. 9 includes the pad 624 and the fiber pipe portion 630c. The package 630 includes a thermoelectric cooler (TEC) 760 inside and a subcarrier (optical element base) 780 arranged on the TEC 760, the optical modulator PIC 727, the chip condenser lens 781, and the fiber condenser lens 782 are arranged on the optical element base 780, and output modulated light to an optical fiber 740. Further, the driver IC 730 is arranged between the module wiring board base 770 and the optical modulator PIC 727.

In order to realize ultra-high-speed operation exceeding 100 GBd, it is preferable that the width W1 of the signal pad 628 and the diameter of the land 626 be as narrow as possible. This is because when the width W1 and the diameter of the land 626 are large, the capacitance of the signal pad 628 becomes large, which causes deterioration of high frequency characteristics. Also, the pads 614 and 624, which are Signal PADs, are very small in size to improve high frequency characteristics. Therefore, in order to ensure connection strength, it is desirable that the size of the pads 613 and 623, which are GND PADs, be set to be twice or more the width of the pads 614 and 624. Setting the size of the pads 613 and 623 to be twice or more the size of the pads 614 and 624 is very effective not only from the viewpoint of connection strength but also from the viewpoint of crosstalk.

The specific size of the width W1 needs to be at least 200 μm or less. However, when the width W1 of the signal pad 628 on the side of the DSP package substrate 610 and the side of the optical modulation module 625 is very small, such as 100 μm or less, for example, on the both sides, there is a possibility that the signal pads may not be properly connected to each other due to manufacturing tolerances, positional deviations during mounting, or the like. Therefore, by setting only the width of the signal pad 628 on the side of the optical modulation module 625 which is often made of a material with a higher dielectric constant, to 100 μm and setting the size of the signal pad 628 on the side of the DSP package substrate 610 to 200 μm to reduce the size of the signal pad 628 only on the side of the optical modulation module 625, it is conceivable to further widen the signal band while ensuring case of mountability. As an example, the signal pad 628 on the side of the optical modulation module 625 is set small, but the pad 614 (Signal PAD) on the side of the DSP package substrate 601 may be set small. However, considering the effect, it is possible to obtain the effect of reducing the capacitance of the portion where the pads are connected to each other by reducing the size of the signal pad 628 on the side of the optical modulation module 625 from the relation of the material constant and the layer structure of the generally used package.

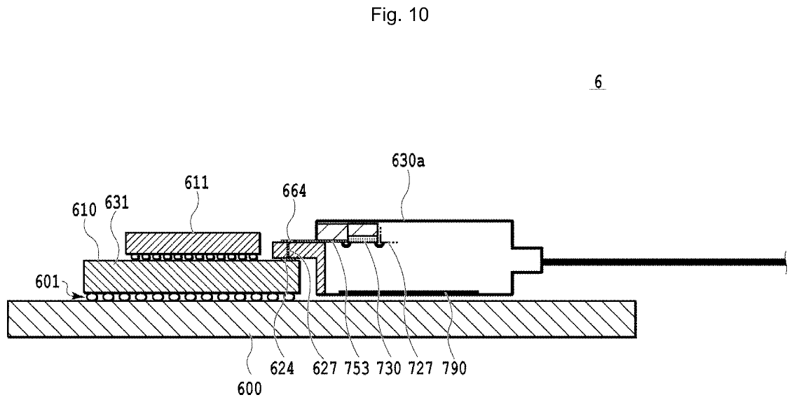

FIG. 10 shows a state in which the optical modulation module 630 shown in FIG. 9 is connected to the DSP package substrate 610. FIG. 10 is intended to describe the connection with the DSP package substrate 610, and the scale and aspect ratio of the optical modulation module 625 do not necessarily match those of FIG. 9. Further, in the optical modulation module 625 in FIG. 10, the main configuration is shown for describing the connections, and some parts are omitted from the illustration.

As shown in FIG. 10, the optical modulation module 625 shown in FIG. 9 is mounted upside down. That is, the optical modulation module is mounted by inverting it from the state shown in FIG. 9, and the optical modulation module is heated all at once using a hot bar from the side of the optical modulation module. By inverting and mounting the optical modulation module in this way, the heat dissipation surface of the modulation module is placed on the upper side. This allows the heat dissipation surfaces of the DSP package substrate 610 and the modulator to be aligned in the upper surface direction. The DSP package substrate 610 and the optical modulation module 625 are connected to each other at high frequency through connection pads. Specifically, the configuration is employed in which the high frequency signal is transmitted from the DSP package substrate 610 to the pads 623 and 624 of the optical modulation module 625 via the pads 613 and 614, further passes from the pads 623 and 624 via the through hole 627 to the heating pads 663 and 664, and is transmitted to the inside of the package 630 by the high frequency wiring 753, and thereby the high frequency signal is propagated to the driver IC and the optical modulator PIC.

For the optical modulator PIC 727, an InP-based IQ optical modulating element with excellent wideband properties is used here. The optical modulator PIC 727 uses an InP substrate and includes at least two Mach-Zehnder type optical interference waveguides.

On the input side of the optical modulator PIC 727, the module wiring board base 770 and a module package wall surface 771 are arranged as the left wall surface of the package of the optical modulation module 625. The module wiring board base 770 and the module package wall surface 771 are made of ceramic having different thicknesses, for example. The high frequency wiring 753 on the upper surface of the module wiring board base 770 passes between the module wiring board base 770 and the module package wall surface 771, and inputs a modulated electrical signal to the optical modulator PIC 727 via the gold wire wiring 751. In order to stabilize the optical lens over a long period of time, the package 630 may be filled with an inert gas such as Ar or N2 and hermetically scaled.

### Connection Method of Electrodes

Next, a method for connecting pads that are electrodes of the present embodiment will be described. The pad size is small, and considering multi-channel integration and miniaturization of modules, the PAD spacing is generally very narrow, about several hundred μm. Therefore, when connecting pads to each other, connections using conductive paste, UV cured resin, or the like are difficult because there is a high risk of short circuits when the paste overflows. Therefore, it is desirable to use a solder that has the characteristic of spreading only on the metal surface. Furthermore, with regard to solder, there is a risk of short circuiting where the pitch is narrow, and thus it is conceivable to use a solder resist in combination. Using solder and solder resist in combination can suppress solder wetting and spreading and reduce the risk of short circuits. At this time, the solder resist is applied to cover the periphery of the pad to be connected.

The solder resist may be used on either the DSP package substrate 610 or the optical modulation module 625, and does not necessarily need to be used on pads on both sides. However, of course, using it on both sides is more effective from the viewpoint of suppressing short risk. When a solder resist is used for either the DSP package substrate 610 or the optical modulation module 625, it is preferable to provide the solder resist on the side of the DSP package substrate 610 because it has higher versatility. This is because it is not common to provide a resist on the ceramic package side due to the manufacturing process. Since the solder is fixed by heating, the configuration of the optical modulation module 625 needs to take heating into consideration. In particular, in the optical modulation module 625, considering the heat resistance of adhesives used to fix optical members and various internal members, it is necessary to maintain the temperature inside the optical modulation module 625 at 150° C. or lower during solder heating. For this reason, the material of the solder in the present embodiment needs to be a low melting point solder having a melting point of 150° C. or lower. An example of a solder having a melting point of 150° C. or lower is Sn-Bi solder.

Next, the process of fixing the pads with a solder will be described. In the manufacturing process of the optical transceiver 6, the DSP package substrate 610 is mounted on the PCB 600 before the optical modulation module 625 is mounted. Therefore, the optical modulation module 625 is fixed to the PCB 600 from above the DSP package substrate 610. It is desirable to heat the pads 613 and 623 and the pads 614 and 624 for connection by heating them all at once using, for example, a hot bar tool.

Heating using a hot bar tool cannot directly heat the upper surface 610a or the lower surface 625bb, but is performed via a heating PAD or through hole formed on the surface of the RF terrace portion 625b of the package 630 on the opposite side from 625bb. Before connection, a solder is provided on at least one of the DSP package substrate side and the optical modulation module package side, and then the optical modulation module side is heated all at once using a hot bar. Considering solder flow and case of heating, a hole diameter of the through hole 627 is preferably φ100 μm or more. Furthermore, since the through hole is empty in this way, this through hole is effective not only for heating but also for additionally pouring solder. In this respect as well, a diameter of φ100 μm or more is a very effective size.

When the thickness h5 of the ceramic layer of the RF terrace portion 625b where the pad on the side of the package 630 is thicker than an appropriate range, sufficient heat for melting the solder cannot be supplied, and excessive heating is required, resulting in heating the entire package 630. For this reason, it is preferable that the thickness h5 of the ceramic forming the pad be 1 mm or less. Note that “thickness” here refers to the overall thickness, regardless of whether the package 630 is a single layer or multilayer.

Furthermore, in order to achieve higher-speed operation, the optical transceiver according to the present embodiment may include not only a modulating element but also a driver IC in the same package. Such a configuration is also called a CDM. Regarding the receiving module, it is desirable from the viewpoint of speeding up that a transimpedance amplifier be integrated with the light receiving element. Such a configuration is also called an ICR.

Furthermore, considering a high speed, it is desirable to use an InP-based optical modulator element in the optical modulation module. However, the temperature of the InP-based optical modulator element needs to be controlled for stable operation. Therefore, in the present embodiment, it is preferable to mount a Peltier element in the package 630 of the optical modulation module 625. The heat dissipation surface of the Peltier element is preferably on the same side as the heat dissipation surface of the driver IC. This is because when the heat dissipation surfaces of the Peltier element and the driver IC are different, both the upper and lower surfaces of the optical modulation module become heat dissipation surfaces, making it difficult to use.

Furthermore, ICs in consideration of high-speed operation have a risk of oscillation. Taking this point into consideration, in the present embodiment, it is desirable to use a radio wave absorber 790 capable of absorbing a frequency band with a risk of oscillation by pasting the radio wave absorber on a lid portion 630d serving as a lid of the package of the digital signal processing circuit, the optical modulation module, and the optical receiving module.

### REFERENCE SIGNS LIST

6 Optical transceiver
600 PCB
610 DSP package substrate
610a Upper surface
611 DSP-ASIC
613, 623, 623, 624 Pad
623a Signal line
625 Optical modulation module
626 Land
627 Through hole
628 Signal pad
629 Underfill agent (conductive adhesive)
630, 631 Package
630a Package body
630b RF terrace portion
630c Fiber pipe portion
630d Lid portion
663, 664 Heating pad
727 Optical modulator PIC
740 Optical fiber
751 Gold wire wiring
753 High frequency wiring
760 Thermoelectric cooler (TEC)
770 Module wiring board base
771 Module package wall surface
780 Optical element base
781 Chip condenser lens
782 Fiber condenser lens
790 Radio wave absorber

1. A high-speed optical transceiver comprising:
a digital signal processing circuit;
a first electrode formed on a first package substrate of the digital signal processing circuit;
an optical element;
a second package that accommodates the optical element; and
a second electrode formed on a surface of the second package,
wherein the first package substrate and the second package are directly connected to each other by the first electrode and the second electrode.

2. The high-speed optical transceiver according to claim 1, wherein the optical element includes at least one of an optical modulating element and a light receiving element.

3. The high-speed optical transceiver according to claim 1, wherein, in the first electrode and the second electrode, a width of a signal pad functioning as a signal line is 200 μm or less, a width of a signal pad of the second package is smaller than a width of a signal pad of the first package substrate, and a through hole for heating is formed.

4. The high-speed optical transceiver according to claim 1, wherein a solder resist is provided on at least one of the first electrode and the second electrode, and the first electrode and the second electrode are connected using a low melting point solder having a melting point of 150° C. or less.

5. The high-speed optical transceiver according to claim 1, wherein the second package is a ceramic package, and a total thickness of a region of the second package where the second electrode is formed is 1 mm or less.

6. The high-speed optical transceiver according to claim 1, wherein a height of a second formation surface on which the second electrode is formed in the second package is equal to or less than a height of a first formation surface on which the first electrode is formed on the first package substrate, and a difference between the height of the first formation surface and the height of the second formation surface is 500 μm or less.

7. The high-speed optical transceiver according to claim 1, wherein the second package is fixed to a support substrate using a conductive adhesive as an underfill agent.

8. The high-speed optical transceiver according to claim 1, wherein the first package substrate and the second package are supported by the same support substrate, and heat dissipation surfaces of the first package substrate and the second package are arranged on a side opposite to the support substrate.

9. The high-speed optical transceiver according to claim 2, wherein,
when the optical element includes the optical modulating element, a driver IC is integrated with the optical modulating element,
when the optical element includes the light receiving element, a transimpedance amplifier is integrated with the light receiving element,
the high-speed optical transceiver further comprises a Peltier element as a temperature adjustment mechanism, and
the Peltier element dissipates heat to the same side as a side from which the driver IC or the transimpedance amplifier dissipates heat.

10. The high-speed optical transceiver according to claim 1, wherein the first package substrate or the second package includes a radio wave absorber in a lid.
